(19) United States
(12) Patent Application Publication
(10) Pub. No.: US 2026/0017585 A1
(43) Pub. Date: Jan. 15, 2026

(54) ASSORTMENT PACK CONFIGURATION AND ALLOCATION SYSTEM

(71) Applicant: Target Brands, Inc., Minneapolis, MN (US)

(72) Inventors: TIMOTHY MURRAY, Seattle, WA (US); SHOBHIT JAIN, Philadelphia, PA (US)

(73) Assignee: Target Brands, Inc., Minneapolis, MN (US)

(21) Appl. No.: 19/264,529

(22) Filed: Jul. 9, 2025

Related U.S. Application Data
(60) Provisional application No. 63/670,499, filed on Jul. 12, 2024.

(51) Int. Cl. G06Q 10/0631; B65B 59/00; G06Q 10/087

(52) U.S. Cl. CPC G06Q 10/06315; B65B 59/001; G06Q 10/087

(57) ABSTRACT

Methods and systems for optimization and deployment of assortment pack configuration and allocation are disclosed. Different items, e.g., variants on a single core item type, may be packed together to reduce shipping costs and limit the impact of stochastic elements in the supply chain. In accordance with example aspects of the disclosure, a scalable ensemble optimization approach is used which initializes, iterates, and finalizes a packing solution in an accurate, computationally-efficient manner. In some examples, the approach described herein utilizes an iteration phase which explores a bilinear structure of the underlying problem and exploits randomness to explore the possible solution space.

### CROSS-REFERENCE TO RELATED APPLICATIONS

The present application claims priority from U.S. Provisional Patent Application No. 63/670,499, filed on Jul. 12, 2024, the disclosure of which is hereby incorporated by reference in its entirety.

### BACKGROUND

A supply chain may include a one or more store locations that sell items directly to customers. Such a supply chain may involve items sourced from a manufacturer or distributor that have different variations (e.g. size, color, style, quantity, flavor, and the like). In such instances, each store within the supply chain may have been carefully assigned a targeted demand of each variation of a given item to reduce waste, optimize product availability, and other metrics. In this context, however, it may be challenging to determine an optimal packaging and distribution of item assortments through a supply chain to physically deliver an assigned targeted demand to each store in a manner that will balance shipping cost and timeliness.

### SUMMARY

Aspects of the present disclosure relate to methods and systems for determining an optimal configuration and allocation of assortment packs of items. In examples, the system considers a predetermined ideal allocation of variants on a single core item type to each of a plurality of retail store locations in a retail enterprise to determine one or more optimized assortment pack configurations. For example, rather than a custom assortment pack for each individual retail store, the one or more optimized assortment pack configurations may be used universally, throughout the retail enterprise. The system may further allocate a specific quantity of each of the optimized assortment pack configurations to each of the plurality of retail stores within the retail enterprise to most efficiently meet the predetermined ideal allocation of each store.

In some instances, a flexible initialization, iteration, and finalization framework is performed to jointly optimize optimal assortment pack configuration and allocation solutions in a scalable manner without compromising accuracy. By applying this approach, the system can simultaneously minimize the number of calculations and explore a greater solution space in a scalable manner without compromising accuracy.

In a first aspect, a method of configuring and allocating assortment packs of a core item for shipment to a plurality of retail locations in an enterprise. The method includes receiving, at a pack optimization system, a set of constraints and a predetermined targeted assortment demand indicating an ideal allocation of each variant on the core item to each of the plurality of retail store locations. Next, in an initialization phase, the method includes: performing a k-means clustering of retail store locations by similarity of predetermined targeted assortment demand to obtain a plurality of store demand distribution clusters, wherein a centroid of each cluster represents a percentage of each variant upon the core item expected to be allocated to the retail stores included in the cluster; generating a set of pack sizes based on the set of constraints; and generating, on a cluster-by-cluster basis, a set of potential pack configurations for each pack size according to the centroid of each respective cluster, wherein each pack configuration includes a series of integer values quantifying a number of units of each variant included in the pack configuration. Then, in an iteration phase, the method includes: performing a simulated annealing process to output one or more adjusted variables within an overall solution space to define a local solution space, wherein the overall solution space is defined, at least in part, by the initial set of pack configurations; and performing a linear integer solving processes within the local problem space to identify optimized configuration and allocation of assortment packs to each of the plurality of retail store locations. Finally, the optimized configuration and allocation of assortment packs is displayed within an interactive pack optimization tool.

In a second aspect, a system is designed for configurating and allocating assortment packs of a core item for shipment to a plurality of retail locations. The system comprises a processing device, a data store comprising a predetermined ideal allocation of each variant on the core item to each of a plurality of retail store locations in a retail enterprise and at least one constraint, and a memory device comprising instructions. The instruction, when executed by the processing device implement a pack optimization system configured to receive, at least one pack configuration constraint and a predetermined targeted assortment demand indicating an ideal allocation of each variant on the core item to each of the plurality of retail store locations. Next, in an initialization phase, the pack optimization system is configured to: perform a k-means clustering of retail store locations by similarity of predetermined targeted assortment demand to obtain a plurality of store demand distribution clusters, wherein a centroid of each cluster represents a percentage of each variant upon the core item expected to be allocated to the retail stores included in the cluster; generate a set of pack sizes based on at the least one pack configuration constraint; and generate, on a cluster-by-cluster basis, a set of potential pack configurations for each pack size according to the centroid of each respective cluster, wherein each pack configuration includes a series of integer values quantifying a number of units of each variant included in the pack configuration. Then, in an iteration phase, the pack optimization system is configured to: perform a simulated annealing process to output one or more adjusted variables within an overall solution space to define a local solution space, wherein the overall solution space is defined, at least in part, by the initial set of pack configurations; and perform a linear integer solving processes within the local problem space to identify an optimized configuration and allocation of assortment packs to each of the plurality of retail store locations. Finally, the pack optimization system is configured to display the optimized configuration and allocation of assortment packs within an interactive pack optimization tool.

In a third aspect, a method of configurating and allocating assortment packs of a core item for shipment to a plurality of retail locations in an enterprise. The method includes receiving, at a pack optimization system, a set of constraints and a predetermined targeted assortment demand indicating an ideal allocation of each variant on the core item to each of the plurality of retail store locations. Then, in an initialization phase, the method includes: performing a k-means clustering of retail store locations by similarity of predetermined targeted assortment demand to obtain a plurality of store demand distribution clusters; generating a set of pack sizes based on at the least one pack configuration constraint; and generating, on a cluster-by-cluster basis, a set of potential pack configurations, wherein each pack configuration includes a series of integer values quantifying a number of units of each variant included in the pack configuration. Next, in an iteration phase, the method includes: performing a simulated annealing process to output one or more adjusted variables within an overall solution space to define a local solution space, wherein the overall solution space is defined, at least in part, by the initial set of pack configurations; and performing a linear integer solving processes within the local problem space to identify a solution, wherein the solution includes a configuration and allocation of assortment packs to each of the plurality of retail store locations. Then, in a finalization phase, the method includes applying one or more heuristic to the solution to return an optimized configuration and allocation solution. Finally, the optimized configuration and allocation solution are displayed within an interactive pack optimization tool.

### BRIEF DESCRIPTION OF THE DRAWINGS

FIG. 1 is a schematic diagram of an item assortment being distributed to a retail store.

FIG. 2 illustrates a schematic diagram of an optimized assortment pack configuration and allocation approach implemented within a retail enterprise.

FIG. 3 illustrates an example network environment in which an assortment pack optimization system may be implemented.

FIG. 4 illustrates an example schematic diagram of the assortment pack optimization system of FIG. 3.

FIG. 5 is a flowchart of an example method performable by the assortment pack optimization system of FIG. 3.

FIG. 6 is a flowchart of an example method performable by the assortment pack optimization system of FIG. 3.

FIG. 7 illustrates an example user interface displaying an output from the assortment pack optimization system of FIG. 3.

FIG. 8 illustrates an example computing system with which aspects of the present disclosure may be implemented.

### DETAILED DESCRIPTION

As briefly described above, embodiments of the present invention are directed to improvements in software used to optimize the physical configuration and allocation of assortment packs of items.

In some examples, assortment box configurations are optimized for particular items within a retail enterprise that are not replenished on a daily basis (e.g. seasonal products, specialized product programs, and the like) in which the particular items have variants on a single core item type (e.g. the single core item having variants in color, size, quantity, style, flavor, and the like.)

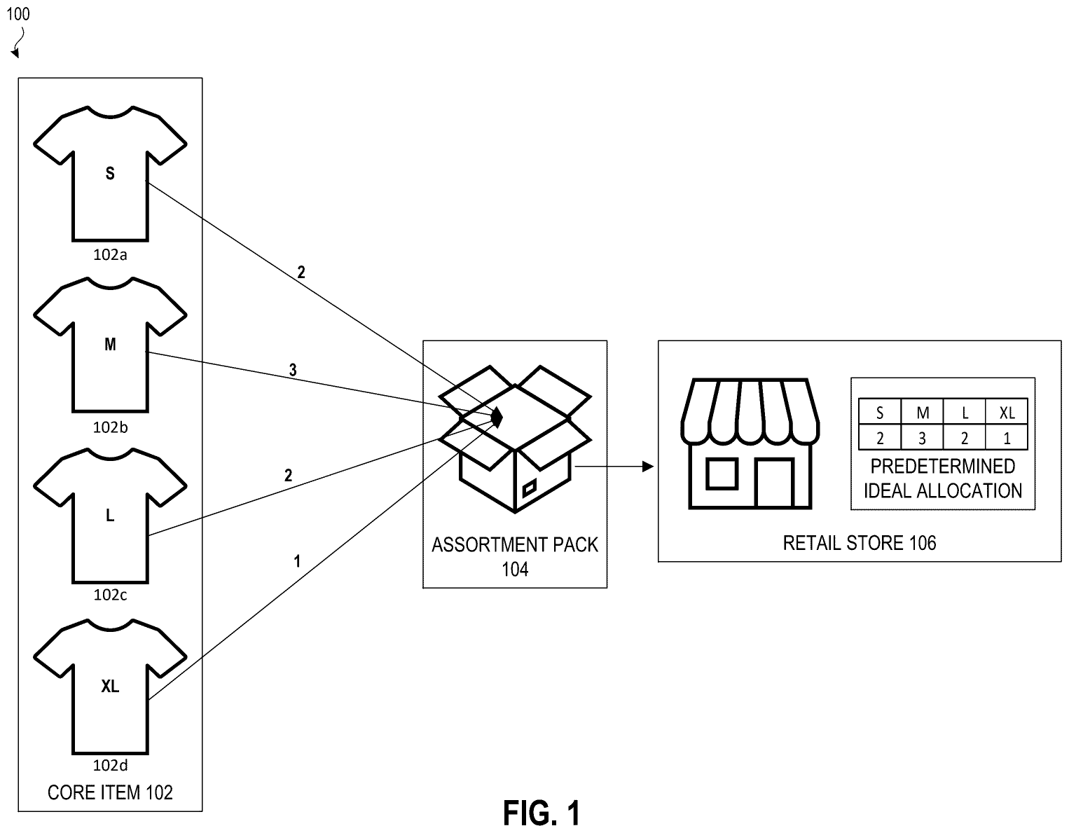

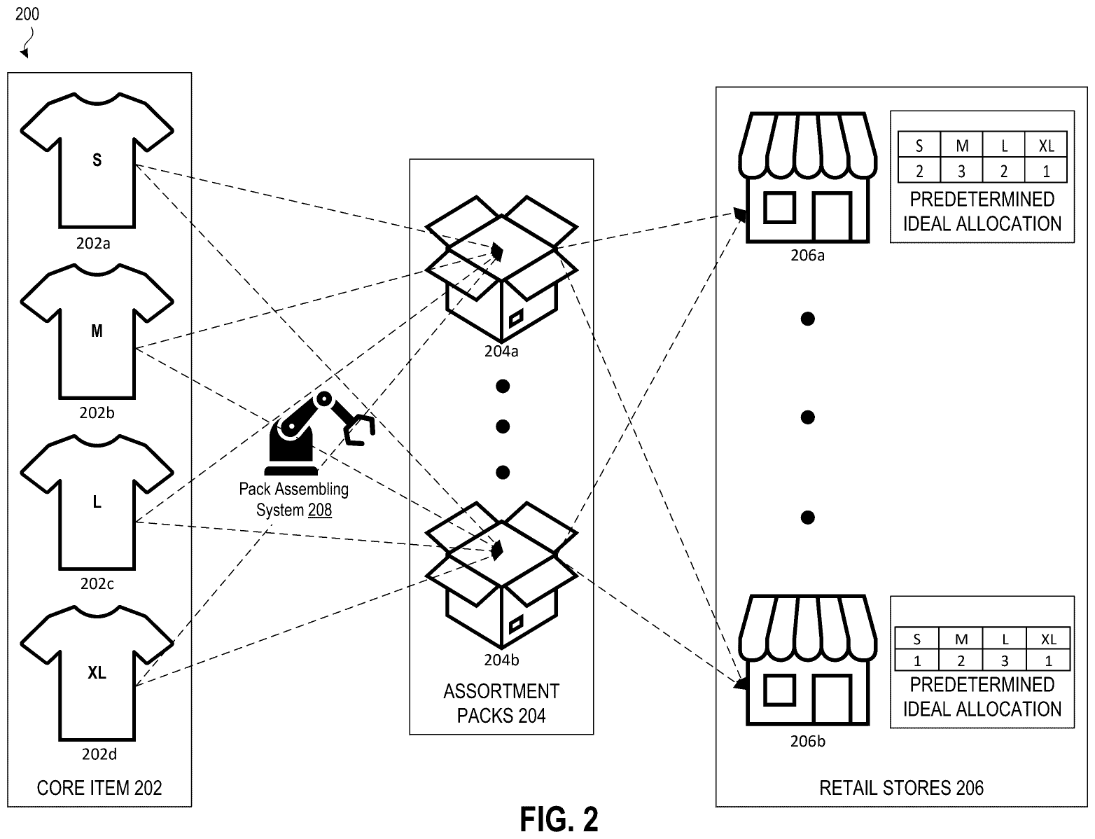

In the context of a retail enterprise, each store may be carefully assigned a targeted demand, or ideal allocation, of each variation of a given core item to reduce waste, optimize product availability, and other metrics. In addition, the ideal allocation for a given store can be influenced by geography, seasonal effects, prior sales metrics for similar items, and the like. In some circumstances, the ideal allocations for one or more (e.g. a plurality of) retail stores within a retail enterprise can be predetermined, prior to the packing and shipment of the core item. In this context, however, it is still necessary to determine an optimal distribution through a supply chain, including packing and shipping strategies, to physically deliver an ideal allocation to each store in a manner that will balance speed and cost. This is particularly true for global supply networks where a 1% decrease in costs can lead to impacts in the tens or even hundreds of millions of dollars (USD). As will be further illustrated and described with respect to FIGS. 1 and 2, these variants upon a core item may be packed together to reduce shipping and other related procurement costs, limit the impact of stochastic elements in the supply chain, maximize delivery speed, and increase efficiency in unpacking and setting up product displays.

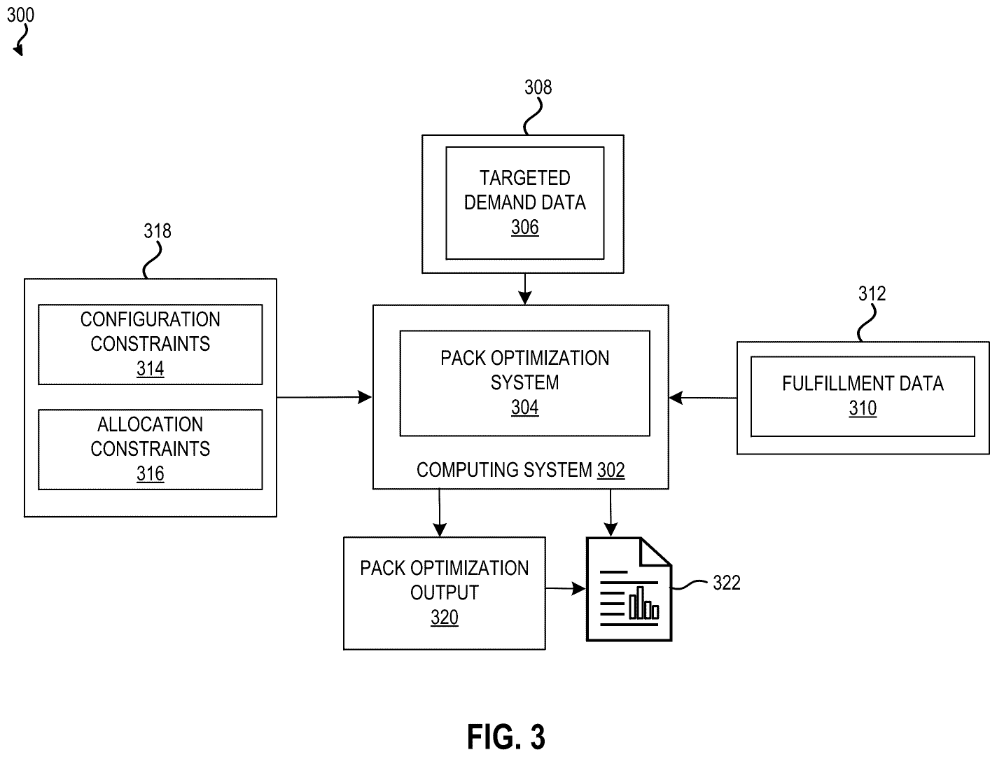

In addition to significant cost saving potential, it is noted that use of the phased approach described herein, described with respect to FIGS. 3-7, including iteration over areas of a potential solution space, provides significant computational improvements over existing approaches.

For example, existing approaches that are capable of accurately identifying an optimal assortment pack configuration for a small set of variables (e.g. through integer programming) are computationally infeasible at any significant scale (e.g. a large number of locations, core items for which assortment pack optimization is desired, and the like). One approach to more efficiently identify a potential assortment pack and allocation solution is to first construct a fixed number of potential solution pack configurations, then identify the best solution from that starting point. However, this approach compromises on accuracy, as there is a risk of missing the true optimal solution, as that optimal solution must have been included in the starting set of potential solution pack configurations.

By contrast, as further described with respect to Table 1, below, the approach described herein has been shown to, simultaneously, enable a reduction in computation time of over 80% along with error reduction in the range of approximately 25%.

For example, in accordance with aspects of this disclosure, to determine an assortment packing solution, a scalable, ensemble optimization approach is used which flexibly initializes, iterates, and finalizes solution in a computationally-efficient manner. In some examples, the approach described herein utilizes a bilinear structure of the underlying problem and exploits randomness through simulated annealing to efficiently explore a potential solution space which includes all possible box configurations. By applying this approach, the system can simultaneously minimize the number of calculations and explore a greater solution space in a scalable manner without compromising accuracy (e.g. the degree to which the optimized solution conforms to an idealized demand).

In example embodiments, the software implements initialization, iteration, and finalization phases, followed by an implementation phase. The initialization phase includes, for example, use of k-means clustering of locations by similarity of demand distribution, as well as linear programming to select a set of initial assortment packs representative of a good fit for that demand distribution. The iteration phase involves a simulated annealing approach to explore different variables that may be adjusted for purposes of optimization, as well as linear programming to search in neighborhoods of potential good solutions for an optimal solution. The finalization phase involves additional linear programming and application of one or more heuristics to identify and apply isolated adjustments to further improve a solution. The implementation phase may include deployment within a retail supply chain, in accordance with example embodiments.

These and other examples will be explained in more detail below with respect to FIGS. 1-8.

FIG. 1 is a schematic diagram of an item assortment being distributed to a retail store. As described herein, an item assortment is one or more variants of a core item. In the example shown, the core item 102 is a shirt that will be supplied in one or more variations (e.g. color, style, size, length, and the like). The item variants illustrated in FIG. 1 (102a, 102b, 102c, and 102d) correspond to different sizes. For example, item variant 102a is a size small, 102b is a size medium, 102c is a size large, and 102d is a size extra-large.

In the example shown, the retail store 106 has been assigned a predetermined ideal allocation of each variant of the core item 102 including: two units of the core item 102 in size small (102a), three units in size medium (102b), two units in size large (102c), and one unit in size extra-large (102d).

As further illustrated in FIG. 1, the predetermined ideal allocation of each variant of the core item 102 item variants are packed together in a single assortment pack 104. This method of assortment packing (packing variants of a single core item together) can reduce shipping costs that would otherwise be experienced by individually shipping one variant at a time. In addition, assortment packing can reduce the impact of stochastic elements in the supply chain, ensuring that the assortment of item variants do not arrive piece-by-piece in different deliveries. This, in turn, eases the process of setting up an assortment display, as all the units are together in a smaller number of boxes, and further ensure that all variants of the core item are available for customers to view and compare in one visit.

However, to realize the advantages of assortment packs in the context of a retail enterprise, additional constraints must be considered. For example, in a retail enterprise having hundreds or thousands of individual store locations, configuring and shipping custom assortment packs for each individual store location based on a predetermined ideal allocation may result in added costs from suppliers, additional steps in the distribution process, or physical packaging and shipping inefficiencies. These added costs, steps, or inefficiencies can ultimately minimize or surpass any cost or time savings that could be realized from delivering assortment packs to each retail store within a retail enterprise.

FIG. 2 illustrates a schematic diagram of an optimized assortment pack configuration and allocation approach implemented within a retail enterprise. This optimized assortment pack configuration and allocation approach may be output by the assortment pack optimization system described with respect to FIGS. 3-7. In the example shown, a core item 202 having a plurality of item variants is to be distributed to a plurality of retail stores 206 within a retail enterprise. A automated pack assembling system 208 is also shown.

The item variants illustrated in FIG. 2 (202a, 202b, 202c, and 202d) correspond to different sizes. For example, item variant 202a is a size small, 202b is a size medium, 202c is a size large, and 202d is a size extra-large. As further illustrated in FIG. 2, each of the retail stores 206 within the retail enterprise has been assigned a predetermined ideal allocation of each variant of the core item 102. In the example shown, retail store 206a has been assigned a predetermined ideal allocation of each variant of the core item 202 including: two units of the core item 202 in size small (202a), three units in size medium (202b), two units in size large (202c), and one unit in size extra-large (202d). Retail store 206b assigned: predetermined ideal allocation of each variant of the core item 202 including: one unit of the core item 202 in size small (202a), two units in size medium (202b), three units in size large (202c), and one unit in size extra-large (202d). In this and other examples described herein, the retail enterprise can include hundreds or thousands of additional retail stores 206 each having its own predetermined ideal allocation of each variant of the core item 202, carefully selected by upstream systems to reduce waste, optimize product availability, and other such metrics.

As illustrated in FIG. 2, one or more (e.g. a plurality of) optimized assortment pack configurations 204 can be defined such that the predetermined ideal allocations of each retail store 206 for each variant of the core item 202 can be met by allocating a specific quantity of each optimized assortment pack configuration 204 to the respective retail store 206. For example, a one or more (e.g. a plurality) of a single optimized assortment pack configuration (e.g. 204a or 204b), a mixture of different optimized assortment pack configurations (e.g. 204a and 204b), or a combination thereof may be allocated to each of the one or more of the retail stores 206 to meet its respective predetermined ideal allocation.

As further illustrated in FIG. 2, in some embodiments an automated pack assembling system 208 can be configured to pack each of a plurality of assortment packs 204 according to the optimized assortment pack configurations. For example, the pack assembling system 208 can be a robotic system configured to automatically place a number of units of each variation upon the core item 202 into a box according to an optimized assortment pack configuration. In some implementations, the automated pack assembling system 208 can further be configured to print shipping labels, place shipping labels on each of the assortment packs 204, or both. For example, the pack assembling system 208 can automatically print shipping labels identifying which retail store 206 each of the assortment packs 204 is to be shipped to according to an optimized allocation of assortment packs. In further examples, the pack assembling system 208 can automatically place a shipping label on each respective assortment pack 204 identifying which retail store 206 the respective assortment pack 204 is to be shipped to according to an optimized allocation of assortment packs. In examples, once all of the assortment packs 204 are assembled and labeled for shipment, the pack assembling system 208 can further be configured to place each of the packed assortment packs 204 into a shipping truck for delivery to one or more retail store.

While this method of jointly optimizing assortment pack configurations and allocation across a retail enterprise may not mean that the demands of each individual retail store are met as precisely as they would be if each item-location demand was allocated to individually, it is nonetheless desirable both in terms of reducing the cost of shipping and distribution with fewer packs variations and limiting the possibility of possibility of partial assortments arriving at a location or assortments arriving piece-by-piece due to the inherently stochastic nature of shipping networks. In this manner, cost, delivery speed, and efficiency in unpacking and setting up product displays can each be flexibly balanced based on the number, configuration, and allocation of optimized assortment packs.

Systems and methods for accurately determining optimized assortment pack configurations and allocation in a computationally efficient, scalable manner are described in further detail with reference to FIGS. 3-8.

FIG. 3 illustrates an example network environment in which an assortment pack optimization system may be implemented. As will be described in more detail below, the system 300 may include a computing system 302, a pack optimization system 304, targeted demand data 306, a demand data store 308, fulfillment data 310, a fulfillment data store 312, configuration constraint data 314, allocation constraint data 316, a constraint data store 318, a pack optimization output 320, and a report visualization 322.

The system 300 may be a networked environment that utilizes logical connections to connect computing systems, data stores, and other devices therein. In some examples, the system 300 includes computing systems, data stores, and other devices that are internal to an enterprise such as a retail enterprise. In other examples, the system 300 can further include computing systems, data stores, and other devices that are external to the enterprise. In examples, each computing system, data store, or device operating within the system 300 may be connected to one another through a network, such as a wireless network, wired network, or other network proprietary to the enterprise. In this manner, each system, data store, or device operating within the system 300 may receive and process input from a different system, data store, or device within the system. Similarly, each system, data store, or computing device operating within the system 300 may output data to a different system, data store, or computing device within the system 300.

The computing system 302 may be configured to receive input data from one or more data sources and provide data to the pack optimization system 304. In some examples, input data may include some or all of: targeted demand data 306; fulfillment data 310; configuration constraint data 314; and/or allocation constraint data 316. Input data may be stored in one or more various databases, which may be virtual (e.g., cloud-based), network based, or drive-based. Examples of databases include one or more of: demand data store 308; fulfillment data store 312; and/or constraint data store 318. In some examples, all of the input data may be stored in a single database or at the computing system 302 itself. In some aspects, the input data may be provided as a data file. In some implementations, a data file may be generated by one or more computing systems by selecting and organizing data input from a plurality of internal or external sources. For example, a data file may be organized to have a standardized format to allow for efficient processing by the pack optimization system 304.

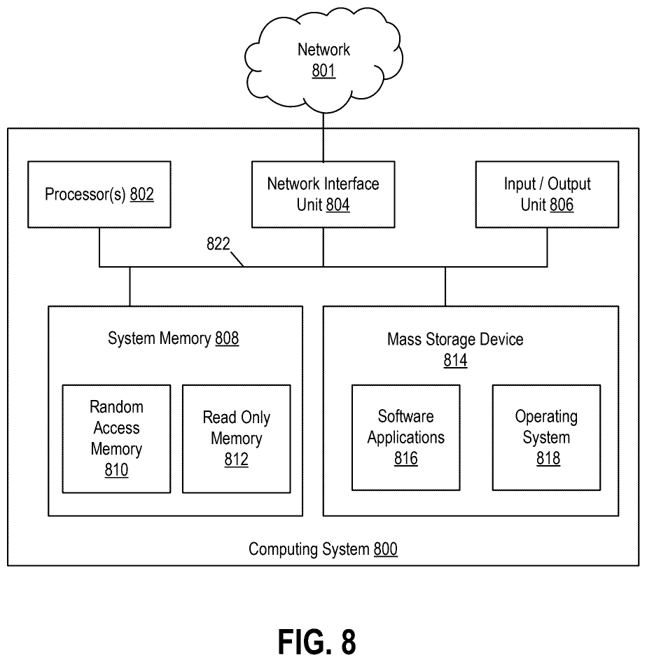

Computing system 302 may be a may be a desktop computer, a laptop computer, a tablet, a cell phone, or other electronic device which is capable of storing and executing instructions that cause the system to receive data and provide data to the pack optimization system 304. An example of such a computing system is described below in conjunction with FIG. 8. In some instances, the computing system 302 may be a cloud or virtualized computing system, or other shared computing resource, including a plurality of execution units.

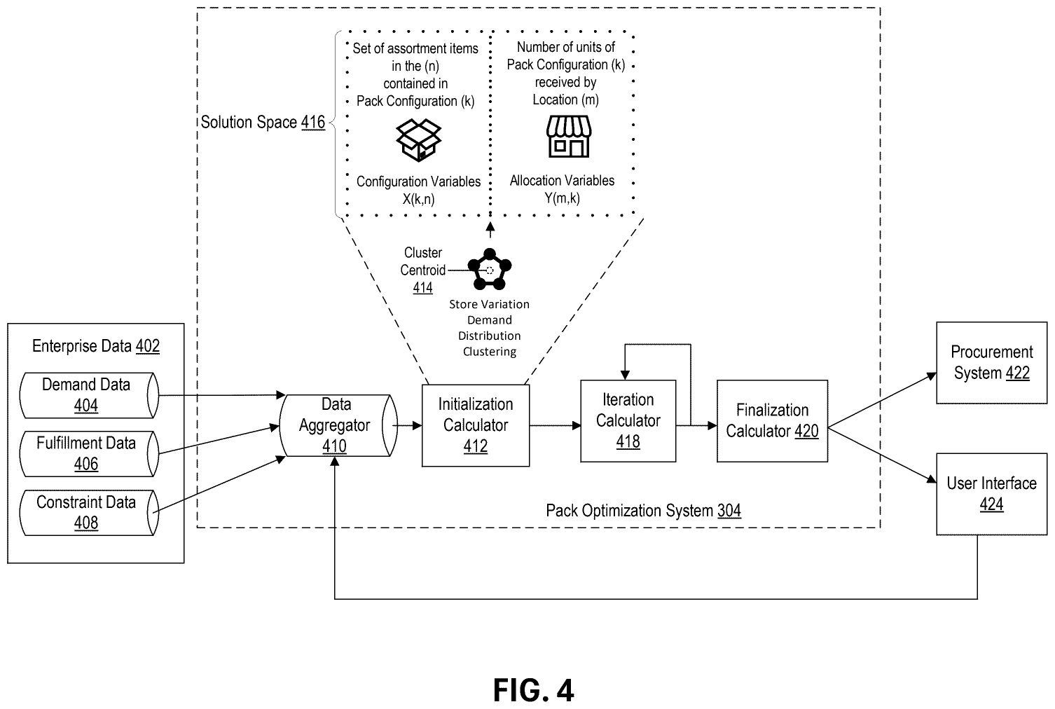

The pack optimization system 304 is configured to receive data from the computing system 302 and generate output data including a pack optimization output 320, one or more report visualizations 322, or both. The pack optimization 304 is further illustrated and described with respect to FIG. 4.

The targeted demand data 306 may indicate an ideal allocation of each variant on a given core item to each retail store within the retail enterprise. For example, targeted demand data 306 may include a store ID indicating a retail store location, a predetermined ideal allocation of each variation upon one or more (e.g. a plurality of) core items to each respective retail store location, and the like. In examples, targeted demand data 306 may be based at least in part on historical demand data such as prior purchase or sales data for each of a plurality of retail store locations or the enterprise as a whole. In other examples, targeted demand data 306 can be generated based on market benchmarks and/or market analysis (for example, actual or predicted market trends). In some embodiments, the targeted demand data 308 can be determined by one or more demand forecasting systems that may receive input data, such as forecasted demand data or prior sales data, and output targeted demand data 308 for one or more retail stores within a retail enterprise. In some examples, the targeted demand data 308 can include the aggregated demand data for each of a plurality of retail stores within the retail enterprise. In some embodiments, the targeted demand data 306 can be stored at the demand data store 308.

The demand data store 308 may include targeted demand data 306 for each of a plurality of retail stores within the enterprise. The demand data store 308 can be communicatively coupled to the computing system 302. In some embodiments, the demand data store 308 is located on a server that is separate from the server on which the pack optimization system 304 operates. In other embodiments, the demand data store 308 is housed within the computing system 302 as the pack optimization system 304.

The fulfillment data 310 can include data related to delivering one or more variation of a core item to one or more (e.g. a plurality of) stores within a retail enterprise. For example, fulfillment data 310 can be the aggregated fulfillment data for each of a plurality of retail stores within the retail enterprise. In some examples, fulfillment data 310 can include cost data or shipping speed data. For example, cost data can include the cost of packing materials based on pack size, number of pack configurations, or number of packs being delivered to each respective retail store within the enterprise. In other examples, cost data can include the cost of shipping based on pack size, number of pack configurations, or number of packs being delivered to each respective retail store within the enterprise. In some examples shipping speed data can include an estimated delivery timeframe based on a distance from a fulfillment source to a retail store destination, shipment route, package carrier, pack size or number of packs being delivered to a retail store. In some embodiments, the fulfillment data 310 can be stored at the fulfillment data store 312.

The fulfillment data store 312 may include fulfillment data 310 for one or more core items to be stocked by one or more retail stores within the enterprise. The fulfillment data store 312 can be communicatively coupled to the computing system 302. In some embodiments, the fulfillment data store 312 is located on a server that is separate from the server on which the pack optimization system 304 operates. In other embodiments, the fulfillment data store 312 is housed within the computing system 302 as the pack optimization system 304. In some examples, fulfillment data 310 can be used by the pack optimization system 304 to determine the efficiency of delivering one or more variation of a core item to a plurality of stores in terms of speed, cost, or both.

The configuration constraint data 314 may include a number of pack configuration constraints to be utilized by the pack optimization system 304 when determining the pack optimization output 320. For example, configuration constraint data 314 can include one or more configuration constraints that are to be applied to a single store, a subset of stores, or the entire enterprise. For example, configuration constraint data 314 can include one or more of: maximum pack size, minimum pack size, maximum packs per location, or minimum units per item per location. In some implementations, the configuration constraint data 314 can be stored at the constraint data store 318.

Maximum pack size can include an upper limit on the number of units that can be included in a pack. For example, the upper limit can be a maximum number of units that can be included in a pack or an upper range of units that can be included in a pack. In some examples, the maximum pack size can be determined from the supply chain network, the item manufacturer, or both.

Minimum pack size can include a lower limit on the number of units that can be included in a pack. For example, the lower limit can be a minimum number of units that can be included in a pack or a lower range of units that can be included in a pack. In some examples, the minimum pack size can be determined to prevent wasted pack space or shipping inefficiencies in terms of cost or speed.

Maximum packs per location can include an upper limit on the total number of boxes that an individual retail store can receive. For example, a maximum packs per location can be determined based on space constraints, cost constraints, or both.

Minimum units per item per location can include a minimum number of units of each assortment item that each location must receive. For example, the minimum units per item per location may be determined to ensure that each retail store receives a full assortment variation upon a core item, even if the targeted demand for one or more variations is low.

The allocation constraint data 316 may include a number of allocation constraints to be utilized by the pack optimization system 304 when determining the pack optimization output 320. For example, allocation constraint data 316 can include one or more allocation constraints that are to be applied to a single store, a subset of stores, or the entire enterprise. For example, allocation constraint data 316 can include total allocation units, impression minimum, or both. In some implementations, the allocation constraint data 316 can be stored at the constraint data store 318.

Total allocation units can include an upper limit on how many units that are available to allocate across the enterprise. For example, the upper limit can be a maximum number of units available to allocate across the enterprise or an upper range of units available to allocate across the enterprise. For example, total allocation units can be determined based on a vendor agreement, historical inventory data, or current inventory totals.

Impression minimum can include a lower limit on the total number of units from a core item assortment that a respective retail store must receive. In some embodiments, impression minimum can include a lower limit on the total number of units of a core item that each retail store, across the enterprise, must receive. For example, the impression minimum may be determined to ensure that the core item is maximally distributed across the retail enterprise.

The constraint data store 318 may include configuration constraint data 314, allocation constraint data 316, or both. The constraint data store 318 can be communicatively coupled to the computing system 302. In some embodiments, the constraint data store 318 is located on a server that is separate from the server on which the pack optimization system 304 operates. In other embodiments, the constraint data store 318 is housed within the computing system 302 as the pack optimization system 304. In some examples, the configuration constraint data 314, the allocation constraint data 316, or both, can be directly input to the pack optimization system 304 via a user interface of the computing system 302.

The pack optimization output 320 may define an optimized assortment pack configuration and allocation strategy for an enterprise. For example, the optimized assortment pack strategy can include one or more (e.g. a plurality of) optimized assortment pack configurations. For example, an optimized assortment pack configuration can indicate a quantity of each variation upon a core item to be packed into a single shipping container. The pack optimization output 320 can also include an optimized assortment pack allocation. An assortment pack allocation can indicate the number of each assortment pack configuration to be shipped to a given retail store within the enterprise. In some examples, the pack optimization output 320 can include at least one assortment pack configuration and at least one assortment pack allocation for at least one retail store within the enterprise. In other examples, the pack optimization output 320 can include a plurality of assortment pack configurations and allocation thereof to a plurality of retail stores within the enterprise.

In some embodiments, the pack optimization output 320 is responsive to the configuration constraints 314, allocation constraints 315, or both, allowing for efficiencies such as predicting a pack optimization output 320 that will be within a given budget. In some embodiments, the pack optimization output 320 may further include a report indicating the total investment or shipping speed associated with the pack optimization output 320 including metrics such as: total shipping cost across the enterprise, average shipping cost for each store across the enterprise, average shipping speed, number of assortment pack configurations, total number of packs enterprise wide, average number of packs allocated to each store across the enterprise, and other values indicating the quality of the output. In this manner, a user can compare one or more pack optimization outputs 320 before implementing assortment pack configuration and allocation solution.

As briefly mentioned, the pack optimization output 320 may be presented to a user. For example, a user may be an employee of a retail enterprise such as such as an inventory analyst, shipping strategist, or procurement specialist. The user may then use the pack optimization output 320 to make decisions for the enterprise, such as assortment pack configurations, assortment pack allocations, or other assortment planning decisions. For example, the pack optimization output 320 can include a comparison between the targeted demand data 306 for one or more store within the enterprise to the actual assortment allocated to each of the respective stores. In another example, the pack optimization output 320 can include a comparison between the targeted demand data 306 and the actual assortments allocated to subset of stores or the enterprise as a whole. In this manner, the accuracy of the pack optimization output 320 can be quickly evaluated and errors or significant deviations can be quickly identified. Furthermore, these decisions may be evaluated on a core-item basis, thus creating a significant efficiency because a decision can be evaluated across all stores in an enterprise rather than each store individually.

In some examples, a plurality of pack optimization outputs 320 can be generated based on an adjustment of one or more constraint and stored for comparison against one another, e.g. in one or more report visualizations 322. For example, the report visualization 322 for a given pack optimization output 320 can be stored for comparison to a subsequent pack optimization output 320 generated by the pack optimization based on one or more adjusted configuration constraint 314, allocation constraint 316, or both. In this manner, a user may dynamically adjust one or more constraint and readily compare cost, speed, and demand accuracy when considering a plurality of possible pack optimization solutions. Example outputs of the pack optimization system are further illustrated and described with respect to FIGS. 4-7.

FIG. 4 illustrates an example schematic diagram of the assortment pack optimization system of FIG. 3. In the example illustrated in FIG. 4, the pack optimization system 304 receives data from one or more enterprise data store 402 and outputs a solution to a procurement system 422, a user interface 424, or both.

As described above, the pack optimization system 304 is configured to generate an optimized assortment pack configuration and allocation solution for physically shipping an assortment of one or more variations upon a core item to one or more retail stores within an enterprise. The pack optimization system 304 illustrated in FIG. 4 includes a data aggregator 410, an initialization calculator 412, an iteration calculator 416 and a finalization calculator 418. A solution space 414 determined by the initialization calculator 412 is also shown.

The enterprise data store 402 includes data enterprise data that is input to the pack optimization system 304. For example, the enterprise data store 402 can be maintained wholly within the enterprise. In some examples, the enterprise data store 402 can receive data from external sources, internal sources, or both. In the example shown, the enterprise data store 402 includes one or more of: demand data 404, fulfillment data 406, and constraint data 408. The enterprise data store 402 can output data to the data aggregator 410.

In examples, demand data 404 may indicate an ideal allocation of each variant on a given core item to each of a plurality of retail store locations within the retail enterprise. For example, demand data 404 may include a store ID indicating a retail store location, a predetermined ideal allocation of each variation upon one or more (e.g. a plurality of) core items to each respective retail store location, and the like. In some examples, the demand data 404 can include the aggregated demand data for each of a plurality of retail stores within the retail enterprise. In other examples, demand data 404 can include may include targeted demand data for the retail enterprise as a whole. In some examples, the demand data 404 can be used, at least in part, by the iteration calculator 412, finalization calculator 416, or both, in determining a pack configuration and allocation solution.

In examples, fulfillment data 406 can include data related to procuring one or more variation of a core item for one or more (e.g. a plurality of) stores within a retail enterprise. In examples, fulfillment data 406 can include cost data or shipping speed data. For example, cost data can include the cost of packing materials based on pack size, number of pack configurations, or number of packs being delivered to each respective retail store within the enterprise. In other examples, cost data can include the cost of shipping based on pack size, number of pack configurations, or number of packs being delivered to each respective retail store within the enterprise. In some examples shipping speed data can include an estimated delivery timeframe based on a distance from a fulfillment source to a retail store destination, shipment route, package carrier, pack size or number of packs being delivered to a retail store. In some examples, the fulfillment data 406 can be used, at least in part, by the iteration calculator 412, finalization calculator 416, or both, in determining a pack configuration and allocation solution.

In examples, constraint data 408 can include at least one pack configuration constraints, at least one pack allocation constraint, or both. Pack configuration constraints can include one or more configuration constraints that are to be applied to a single store, a subset of stores, or the entire enterprise. For example, as discussed with respect to FIG. 3, pack configuration constraints can include one or more of: maximum pack size, minimum pack size, maximum packs per location, or minimum units per item per location. Pack allocation constraints can include one or more allocation constraints that are to be applied to a single store, a subset of stores, or the enterprise as a whole. For example, as discussed with respect to FIG. 3, pack allocation constraints can include one or more of: maximum pack size, minimum pack size, maximum packs per location, or minimum units per item per location. In some examples, the constraint data can be used, at least in part, by the initialization calculator 412 in determining a solution space 414. In some examples, the constraint data 408 can also be used, at least in part, by the iteration calculator 412, finalization calculator 416, or both, in determining a pack configuration and allocation solution.

Data aggregator 410 receives enterprise data from one or more database of the enterprise data store 402. For example, data aggregator 410 can receive demand data 404, fulfillment data 406, constraint data, or a combination thereof. In some examples, the data aggregator 410 can receive data directly from a user via one or more user interface 424. For example, as will be further discussed herein, one or more constraint can be input via a user interface in a dynamic manner such that one or more optimization scenarios can be performed. In other examples, one or more demand dataset, fulfillment dataset, or both can be input by a user via a user interface 424 to quickly evaluate or revise optimal pack configuration and allocation solutions in response to contemporaneous supply chain factors. In some examples the data aggregator 410 can pre-process or convert one or more data file into an aggregated dataset having a standardized format to allow for efficient processing by the pack optimization system 304. The data aggregator can output the aggregated dataset to the initialization calculator 412.

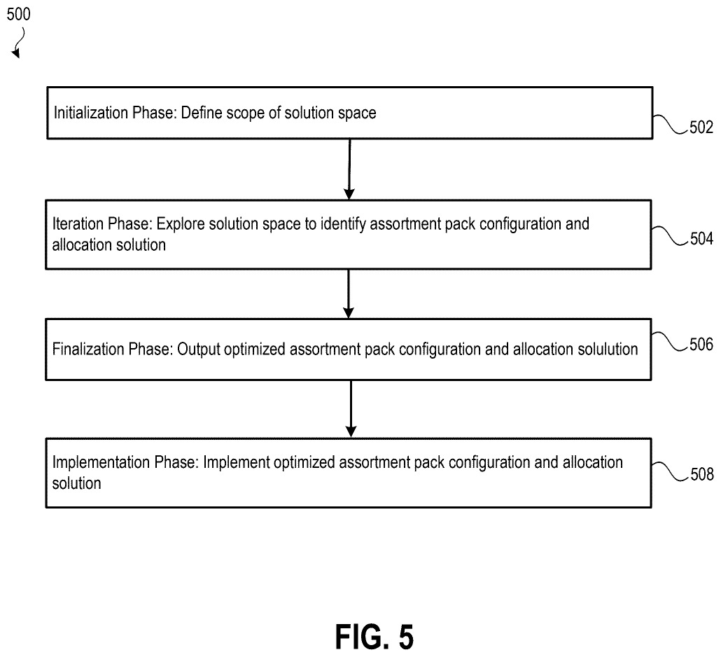

Initialization calculator 412 receives aggregated data from the data aggregator 410. In examples, the initialization calculator may perform an initialization phase as further described with respect to FIG. 5 (operation 502). In some aspects, the initialization calculator 412 define the scope of the solution space to be explored by the pack optimization system. In some examples, a solution space 416 can be defined, at least in part, by a set of potential pack configurations. For example, the solution space 416 can be configured as a bilinear structure of the underlying configuration-allocation problem. In some examples, the solution space 416 may be nonconvexing such that there may be a plurality of local optima that must be explored to determine a global optimum. In examples, the initialization phase can include assigning each of the plurality of retail store locations to a cluster based on a targeted assortment demand. As further described with respect to FIG. 5, a plurality of clusters of store item variation selling distributions can be formulated and the centroid 414 of each respective cluster representative of a percentage of each variation upon a core item that each cluster is expected to be allocated. For example, the centroid 414 of each cluster can represent the percentage of each variation upon a core item pre-assigned to the retail stores included in the cluster, based on targeted demand. In this manner, the stores that are expected to be allocated similar percentages of each variation within an item assortment are clustered together, regardless of the targeted volume of each store. In some embodiments, the initialization calculator 412 may perform an initialization phase may identify an initial set of assortment pack configurations. In implementations, as described with respect to FIG. 5, an initial set of assortment pack configurations, identified within the solution space 416 as best maximizing one or more objectives or constraints may be recorded as an initial set of assortment pack configurations or initial starting solution. The initialization calculator 412 may output data related to the solution space 416, an initial starting solution, or both to the iteration calculator 416.

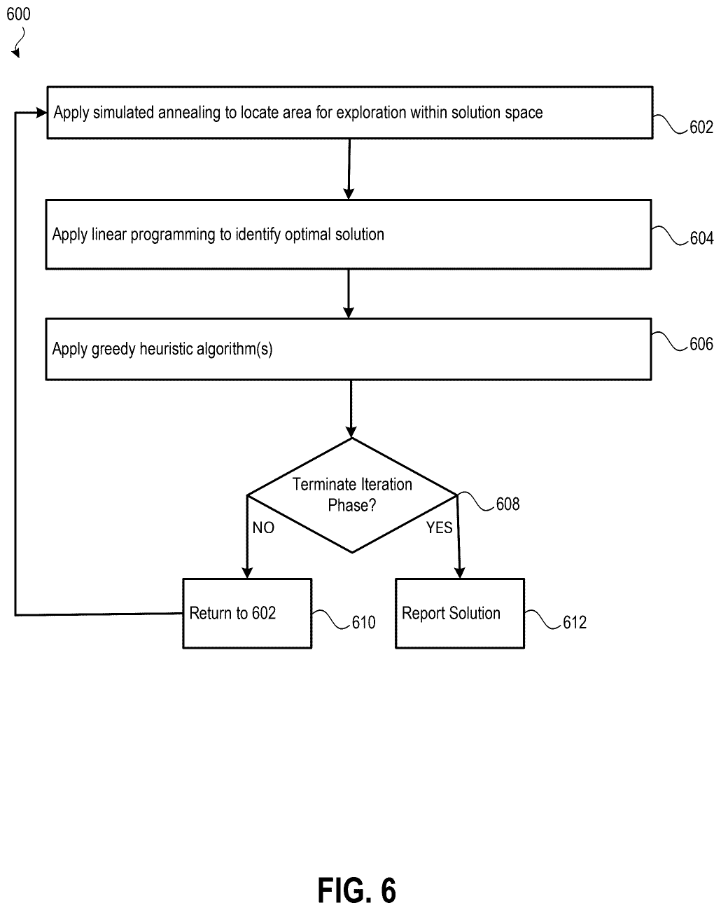

Iteration calculator 418 can receive data from the initialization calculator 412. In examples, the iteration calculator 418 may perform an iteration phase to identify an assortment pack configuration and allocation solution as further described with respect to FIG. 5 (operation 504) and FIG. 6. The iteration phase can be performed to further refine a set of assortment pack configurations, based on the initial set of assortment pack configurations received from the initialization calculator 412, to define an assortment pack configuration solution. In some examples, the iteration phase can be performed to define an allocation of each assortment pack configuration to each of a plurality of retail stores within the enterprise to determine an assortment pack allocation solution. The iteration calculator 418 may output an assortment pack configuration and allocation solution to the finalization calculator 420.

Finalization calculator 420 may receive an assortment pack configuration and allocation solution from iteration calculator 418. In examples, the finalization calculator may perform a finalization phase as further described with respect to FIG. 5 (operation 506). For example, a finalization phase can include one or more finalization operations to further refine the assortment configuration solution received from the iteration calculator 418. For example, the finalization calculator may apply an impression minimum fulfillment heuristic to ensure that, if there are any leftover assortment packs, that they are allocated to locations which are under the impression minimum. Further finalization operations are described with respect to FIG. 5. The finalization calculator may send one or more optimized assortment pack configuration and allocation solution to one or more systems to perform an implementation phase. In examples, the finalization calculator may send an optimized assortment pack configuration and allocation solution to the procurement system 422, the user interface 424, or both.

Procurement system 422 may receive an optimized assortment pack configuration and allocation solution from the finalization calculator 420. In examples, the procurement system 422 may automate the implementation of the optimized assortment pack configuration and allocation solution. For example, the procurement system 422 may automatically format and send an order for a set of assortment pack configurations to a supplier. In some examples, the procurement system 422 may automatically format and send the supplier an order of one or more assortment pack configurations, within the set, to be sent to one or more retail store. In other examples, the procurement system 422 may automatically format and send one or more enterprise systems an assortment pack configuration and allocation order. For example, the procurement system 422 may automatically send an allocation of one or more assortment box configurations to an enterprise warehouse system. In this manner, the enterprise warehouse can send the optimized allocation of assortment box configurations to each of a plurality of retail stores once they are received from a supplier.

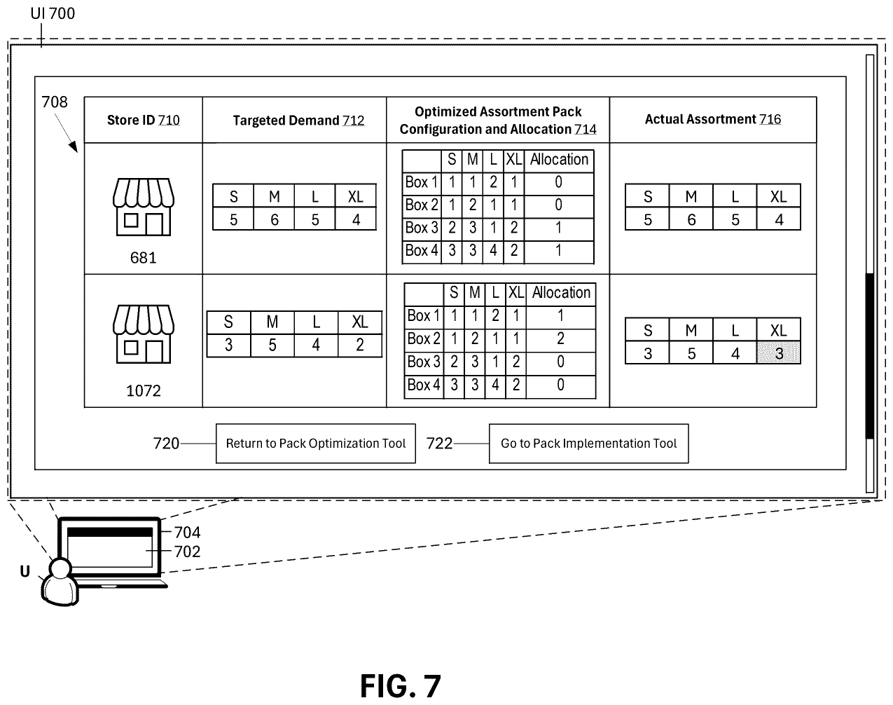

User interface 424 can receive an optimized assortment pack configuration and allocation solution from the finalization calculator. In embodiments, the user interface 424 can also receive one or more datasets from the data aggregator 410. For example, the user interface 424 can be the user interface of the computing system of a user such an inventory analyst, fulfillment analyst, procurement analyst, or warehouse analyst. In examples, the user interface 424 can allow a user to quickly define one or more constraints, evaluate one or more potential scenario, accurately identify an optimized solution and automatically apply that solution from a single tool. An example user interface is illustrated and described in further detail with respect to FIG. 7

FIG. 5 is a flowchart of an example method 500 performable by the assortment pack optimization system of FIG. 3. In some implementations, the method 500 may be a heuristic ensemble approach broken into operations 502, 504, 506, and 508.

In the example shown, the pack optimization system 304 may perform an initialization phase (operation 502). For example, the initialization phase may be performed to define the scope of the solution space to be explored by the pack optimization system 304. In some examples, the initialization phase can include assigning each of the plurality of retail store locations to a cluster based on a targeted assortment demand. For example, the pack optimization system 304 may normalize the targeted assortment demand for each location for each variation upon a core item. The pack optimization system 304 may further cluster the retail store locations together into one or more clusters by applying one or more algorithm to the demand distribution of the core item assortment experienced by each store. For example, the pack optimization system 304 can apply a k-Means clustering algorithm. In embodiments, the pack optimization system 304 can perform a k-Means clustering of store locations by similarity of targeted demand for each location for each variation upon a core item to obtain a plurality of store demand distribution clusters. For example, the pack optimization system 304 can cluster each of the store locations into a predefined number of clusters, each cluster having with it an associated centroid. In implementations, a plurality of clusters of store item variation selling distributions can be formulated and the centroid of each respective cluster can be determined to represent a percentage of each variation upon a core item that each cluster is expected to be allocated. For example, the centroid of each cluster can represent the percentage of each variation upon a core item pre-assigned to the retail stores included in the cluster, based on targeted demand. In this manner, the stores that are expected to be allocated similar percentages of each variation within an item assortment are clustered together, regardless of the targeted volume of each store. For example, a first store targeted to sell two units of item variation A, two units of item variation B, and two units of item variation C will be clustered together with a second store targeted to sell twenty units of item variation A, twenty units of item variation B, and twenty units of item variation C. In this example, both the first store and the second store are targeted to sell approximately 33% of each item variation.

In some embodiments, the predefined number of clusters can be based on the maximum number of box configurations. For example, if a configuration constraint defines that a maximum of 3 assortment boxes can be configured, then the initialization phase will cluster all of the retail stores together into three clusters based on core item variation selling distribution. In this manner, the scope of the solution space can be efficiently determined, in terms of potential pack configurations, while maintaining quality by equally accounting for each of the retail stores, based solely on relative demand distribution, across an assortment, without utilizing additional computing resources and time to account for relative volume, which can be optimized for separately when determining an optimized allocation of any of the potential pack configurations for each retail store location.

In some examples, the initialization phase can further include generating a comprehensive set of potential pack configurations for each of the location clusters. For example, the pack optimization system 304 may determine a maximum and minimum initial assortment pack size. In some embodiments, the maximum and minimum initial assortment pack size may be determined based on configuration constraint data. In some examples, the pack optimization system 304 can generate a comprehensive set of all potential pack sizes and iterate, over each potential pack size, a potential pack configuration on a cluster-by-cluster basis, based on the centroid of each respective cluster. In this manner, for each given pack size, one or more potential pack configuration can be determined based on the demand distribution of the cluster, with item variation entries rounded to the nearest integer. For example, for a cluster of stores having a centroid representing that the retail stores included in the cluster are preassigned approximately 33% of each variation upon a core item pre-assigned, based on targeted demand, a plurality of potential pack configurations for each potential pack size can be determined for that cluster. For example, the potential configurations of a pack size of ten units, across three core item variations, X, Y, and Z, for a cluster having an evenly distributed 33%, 33%, and 33% item variation demand centroid can be: 3 units of variation X, 3 units of variation Y, and 4 units of variation Z; 3 units of variation X, 4 units of variation Y, and 3 units of variation Z; and 4 units of variation X, 3 units of variation Y, and 3 units of variation Z.

In some examples, the initialization phase can further include identifying an initial set of assortment pack configurations within the comprehensive set of potential pack configurations. For example, the initial set of assortment pack configurations can be the assortment packs within the comprehensive set of potential pack configurations identified as best satisfying at least one of an objective value or a constraint value. For example, objective values or constraint values can be determined based on one or more inputs to the optimization system 304 (e.g. shipping speed, shipping cost, targeted demand data, and other inputs). In some examples, a linear program solver can iteratively evaluate, over all permutations of potential assortment pack configurations, which best conforms to the one or more objective or constraint value to identify and select an initial set of assortment pack configurations. For example, in each iteration, the linear program solver can identify the performance of the respective assortment pack configuration permutation with respect to one or more objective or constraint. Starting with the first iteration being recorded as the incumbent solution, if the current iteration improves the existing incumbent solution, then it becomes the updated incumbent solution, otherwise, the existing incumbent is kept.

In some examples, the pack optimization system 304 can perform an initialization phase until an initial set of assortment pack configurations which best conforms to the one or more objective or constraint value is identified (e.g. via the linear program solver). In other examples, the pack optimization system 304 can perform an initialization phase until a maximum computation time limit is reached (e.g. 75 seconds), at which point the best set of configurations that have been determined within that time limit will be identified as the initial set. Once an initial set of assortment pack configurations has been identified, the pack optimization system 304 may proceed to operation 504.

In the example shown, the pack optimization system 304 may perform an iteration phase (operation 504) to explore the solution space to identify an assortment pack configuration and allocation solution. In some examples, the iteration phase can be performed to refine a set of assortment pack configurations, based on the initial set of assortment pack configurations to define an assortment pack configuration solution. In some examples, the iteration phase can be performed to define an allocation of each assortment pack configuration to each of a plurality of retail stores within the enterprise to determine an assortment pack allocation solution. In some examples, once the pack optimization system 304 has identified an assortment pack configuration and allocation solution, the pack optimization system 304 may proceed to operation 506. An example of operation 504 is further illustrated and described with respect to FIG. 6.

In the example shown, the pack optimization system 304 may perform a finalization phase (operation 506) to output an optimized assortment pack configuration and allocation solution. For example, after completing the iteration phase, the pack optimization system 304 may perform one or more finalization operations before outputting a solution. In some examples, a finalization operation can include solving the linear program a final time. Starting with the incumbent solution, if the result represents an improvement, it replaces the incumbent, otherwise the incumbent is kept.

In some examples, a finalization operation can further include applying one or more greedy heuristic algorithms. For example, the finalization operation can apply one or more of: allocation improvement heuristic, pack improvement heuristic, or impression minimum fulfillment heuristic to further enhance the solution. As will be further discussed with respect to FIG. 6, the allocation improvement and allocation improvement heuristics can be applied to search for obvious improvements to the current set of assortment pack configurations and allocations. In some examples, the pack improvement and the impression minimum fulfillment heuristics may not effectively meet the impression minimum constraint. Therefore, the impression minimum fulfillment heuristic can subsequently be applied to ensure that, if there are leftover assortment packs, that they are allocated to locations which are under the impression minimum. In some examples, the impression minimum fulfillment heuristic can check whether each of a plurality of retail stores fulfill the impression minimum constraint and, if not, whether adding one or more leftover pack configuration would violate an overstocking constraint. In some examples, the one or more leftover pack will be added to a store not meeting an impression minimum, even if it would otherwise slightly decrease the solution quality in terms of accuracy with respect to allocation to targeted demand fit. In examples, the impression minimum fulfillment heuristic may only be applied in the finalization phase, rather than the iteration phase, because, unlike the allocation improvement and pack improvement heuristics, it may have the potential to reduce a current solution quality (e.g., by over allocating one or more item variants to a store). In some examples, once the pack optimization system 304 has output an optimized assortment pack configuration and allocation solution, the pack optimization system 304 may proceed to operation 508.

In the example shown, the pack optimization system 304 may perform an implementation phase (508). In examples, the implementation phase may include packing and shipping one or more assortment packs according to the optimized assortment pack configuration and allocation solution. In some examples, the implementation phase may include automatically formatting an ideal assortment pack configuration and allocation into an order form. In further examples, the implementation phase may include automatically sending an order to a supplier according to an ideal assortment pack configuration and allocation solution. In some embodiments, the implementation phase may be executed by the procurement system 422. For example, the procurement system 422 may automatically send an allocation of one or more assortment box configurations to an enterprise warehouse system. In this manner, the enterprise warehouse can send the optimized allocation of assortment box configurations to each of a plurality of retail stores once they are received from a supplier. In some examples, the implementation phase may be executed via the user interface of an inventory analyst, as illustrated and described with respect to FIG. 7. In some embodiments, the implementation phase can include sending the optimized assortment pack configuration and allocation solution to a remote system. For example, the optimized assortment pack configuration and allocation solution can be automatically sent to a remote packing system. In examples, the optimized assortment pack configuration and allocation solution can be automatically sent to a remote packing system and program a pack assembling robot to place a correct number of units of variations upon a core item into a box according to an optimized configuration. For example, the output of the pack optimization system 304 can be configured as a file to be sent to a remote system and used to program the pack assembling system 208 as illustrated and discussed with respect to FIG. 2.

FIG. 6 is a flowchart of an example method 600 of performing an iteration phase. Method 600 may be performable by the pack optimization system of FIG. 3. In example embodiments, the pack optimization system 304 may perform method 600 to explore a solution space to identify an assortment pack configuration and allocation solution. In examples, the pack optimization system 304 can refine a set of assortment pack configurations, based on an initial set of assortment pack configurations to define an assortment pack configuration solution. In examples, as discussed with respect to FIG. 4, a solution space can have a plurality of local optima and one global optima (e.g. the best local optima). In some embodiments, the pack optimization system 304 may perform method 600 can search for the best local optima rather than searching for a global optima all at once. For example, the method 600 can include searching for the best local optima through a combination of simulated annealing steps prior to solving a linear program rather than searching for the global optima through linear programming all at once. In examples, the method 600 can include searching for the best local optima the within a set of iteration constraints (e.g. a reasonable amount of time, reasonable number of simulated annealing steps, reasonable number of iterations, a quantified improvement upon an initial solution, or the like). Overall, this iterative method has significant advantages in terms of simultaneously enhancing both computational efficiency (as the solution space can be explored more efficiently through the use of less intensive simulated annealing steps prior to solving a linear program) and also accuracy (as the incorporation of randomness can prevent the pack optimization system 304 from becoming trapped in one local optima before identifying the best local optima). In some examples, the iteration phase can be performed to define an allocation of each assortment pack configuration to each of a plurality of retail stores within the enterprise to determine an assortment pack allocation solution. In the example shown, method 600 includes operations 602, 604, 606, 608, 610, 612, and 614.

In the example shown the pack optimization system 304 may locate one or more area for exploration within the solution space (operation 602). For example, once an initial set of assortment pack configurations have been determined in the initialization phase, the optimization system 304 may iteratively improve the pack configurations, allocations, or both. These iterations may be performed as a simulated annealing process in the form of one or more simulated annealing steps. For example, due to the integer and nonconvex nature of the solution space, simulated annealing can provide an effective method to explore the solution space both in terms of pack configurations and pack allocations without becoming trapped in a local optima. In some examples, each simulated annealing step can return one or more adjusted assortment pack configurations. In examples, each solution returned by a simulated annealing step can be an integer solution. In this manner, only whole numbers of variations within an assortment of a core item are returned (not fractions of items).

In some examples, the pack optimization system 304 may apply simulated annealing process in the form of a random walk. For example, a random walk can include steps taken probabilistically within the solution space of the problem in terps of the X and Y variables illustrated with respect to FIG. 4. For example, steps can be represented by a k×n X-step and m×k Y-step matrix. By applying a random walk, the pack optimization system 304 can explore a larger amount of the solution space 414 and uncover one or more local optima.

In some implementations, the pack optimization system 304 may evaluate at all variables at random. However, in some solution spaces, due to the number of retail stores (e.g., m variables far exceeding the k and n variables), nearly all of the exploration would take place in the Y matrix, despite the X and Y matriceshaving equal importance in determining an optimal solution. For example, in some solutions the number of possible pack allocation variables can be significantly greater than the box configuration variables such that the box configuration variables may rarely, if ever, be chosen at random. To account for this, a proportion tuning metric may be applied to the simulated annealing steps such that the pack configuration and allocation variables are explored, respectively, for a fixed proportion of a iterations, simulated annealing steps, measured improvement upon an initial solution, or the like). For example, a proportion tuning metric can determine how much of a step size s should occur in the X matrix and how much should occur in the Y matrix. In some examples, a proportion tuning metric can be assigned to the simulated annealing steps such that the pack optimization system 304 may explore the box configuration variables 10% of the simulation time and box allocation variables 90% of the simulation time.

In embodiments, after a simulated annealing step is taken, the resulting solution is scored via a penalized scoring methodology. In examples, a penalized scoring methodology can include identifying any over- or under-sized pack and apply a penalty to the solution score based on the size of the pack violation times the number of that pack which were allocated in the solution. In this manner, the penalized scoring methodology can be applied to determine the effectiveness of a solution in terms of conforming to one or more constraints, guide simulating annealing steps to primarily feasible regions, or both.

The quality of the resulting solution of each simulated annealing steps can be evaluated in terms of accuracy relative to a target demand, in meeting one or more constraints, or a combination thereof. In examples, the starting solution of the simulated annealing steps is recorded as the starting solution state. If the resulting solution of the subsequent simulated annealing step is better than the starting solution, then it becomes the new solution state. In examples, once a simulated annealing step is taken, if the resulting solution is better than each of the previous simulated annealing steps, then it becomes the new solution state. In some embodiments, a new solution can become the new solution state periodically or at random, even if worse than one or more preceding solution. This random acceptance of solution states can allow the simulated annealing steps to to avoid getting trapped in a local optima and enter new areas for exploration within the solution space.

While this simulated annealing process provides an effective way to avoid being trapped in a local optima, it is not the most efficient method for exploring more deeply within that area of the solution space. For that reason, after a certain set of simulated annealing steps a linear program can be periodically solved. In some examples, a minimum number of simulated annealing steps can be defined that the system 304 must complete prior to before solving the linear program. For example, the simulated annealing process can uncover a local solution space within the overall solution space such that linear programming can then be applied to a more focused, local solution space. In examples, the pack optimization system 304 will complete between at least 5,000 and 50,000 simulated annealing steps before solving the linear programming. In this manner, the operation 602 can balance exploring a wide area of the solution space before identifying a true local optima and applying the more computationally extensive linear programming process

As mentioned, in some implementations the pack optimization system 304 apply linear programming during the iteration phase to determine an optimized solution within the local solution space 414 (operation 604). Not only does applying linear programming to a local solution space conserve time and computational resources, but it also increases the likelihood of the pack optimization system 304 will identify a local optima, global optima, or both. For example, linear programming may be used periodically during the iteration phase. For example, a linear program can iteratively be solved after a certain number of simulation steps. As in the simulated annealing steps, the solution provided by the linear program is accepted as the new solution if it is better than the current solution. In embodiments, as with in the simulated annealing steps, the solution provided by the linear program can be accepted as the new solution periodically or at random.

In some embodiments, after solving the linear program, the pack allocation system 304 can apply one or more heuristic algorithm (operation 606). For example a allocation improvement heuristic algorithm, a pack improvement heuristic algorithm, or both can be applied to compensate for any loss in the linear program solution quality caused by rounding down to integer values. For example, a pack improvement heuristic algorithm can check whether increasing the number of units of each item in a pack by one would improve the solution, without violating any constraints. In examples, the pack improvement heuristic algorithm can terminate after iterating through each item, within each pack at least once. For example, an allocation improvement heuristic algorithm can check iterate over locations to determine, for each location, whether adding an additional pack configuration would improve the solution quality without violating one or more constraint. In some examples, the allocation improvement heuristic can terminate once it has iterated over a full cycle of all locations without improvement. In embodiments, one or more heuristic algorithm can be applied at random or periodically during the iteration phase to balance utilization of computational resources and solution accuracy. As in the simulated annealing steps, the solution provided by a heuristic algorithm is accepted as the new solution if it is better than the current solution. In embodiments, as with in the simulated annealing steps, the solution provided by a heuristic algorithm can be accepted as the new solution periodically or at random.

In some embodiments, the pack optimization system 304 can determine when to terminate the iteration phase (operation 608). In examples, after a certain number of steps, even if the iteration phase is still finding improvements upon prior solutions, the respective improvements can be of diminishing scale over time. In some instances diminishing returns can indicate that the iteration phase has either been trapped in a local optima or has identified a global optima. In some examples, the pack optimization system 304 can terminate the iteration phase after a fixed number of linear programming steps. In examples, the iteration phase can be terminated after between 5 and 15 linear programming steps. In other examples, the pack optimization system can terminate the iteration phase after a fixed number of simulated annealing steps. after 11 linear programming steps. For example, the iteration phase can be terminated after between 0.5 and 1.5 million simulated annealing steps. In some examples, the iteration phase can be terminated if a new solution hasn't been identified within a certain amount of time. For example, the iteration phase can be terminated if a new solution hasn't been identified in over 5 minutes. In other examples, if an improvement has not been identified for a certain proportion of the total simulation time, then the iteration phase will be terminated. For example, if an improved solution has not been identified for more than half the simulation time at any given point, then the iteration phase will be terminated. In still other examples, if an improved solution has not been identified for more than a quarter of the simulation time at any given point, then the iteration phase will be terminated. In this manner, the efficiency of the overall pack optimization system 304, and related computing resources, can be reserved if diminishing returns on solution improvements are being identified.

If the iteration phase is not terminated at operation 608, then the pack optimization system 304 can return operation 602 (operation 610). For example, the pack optimization system 304 can return apply further simulated annealing steps to continue exploring the solution space, periodically solving the linear program for a given space to identify local or global optima.

In some examples, if the iteration phase is terminated, then the best, overall solution identified in the iteration phase will be reported (operation 612). For example, the solution determined by the integration phase can be reported to one or more systems within the environment 300. In some examples, the solution identified in the iteration phase can be reported to the finalization calculator of the pack optimization system 304. For example, after terminating the iteration phase, the pack optimization system 304 will proceed to the finalization phase described with respect to FIG. 5.

With respect to FIGS. 3-6, generally, techniques of the pack optimization system 304 have been empirically evaluated against existing methods, representative of the state of the art, on a collection of 10 datasets, each dataset centering on items in apparel product lines and their different size variations. As shown in Table 1, below, the pack optimization system 304 was compared against the exiting Target method and the Kolon Method. The Kolon Method refers to the approach introduced in Sung et al. (2017): Assuming the correct assortment pack exists as a subset of packs being considered, the Kolon method will find them and return the optimal solution. Therefore, the Kolon Method was selected for this evaluation to ensure that the pack optimization system 304 does not sacrifice solution quality to improve computation speed.

TABLE 1
Numerical Results Demonstrating Scalability and Allocation Accuracy

| | | | | | Previous Target | | Pack Optimization System | | | | | |
|---|---|---|---|---|---|---|---|---|---|---|---|---|
| | | | | | Method | | 304 | | | Kolon Method | | |
| | | | | | Allocation | Time | Allocation | Error | Time | Allocation | Error | Time |
| Dataset | M | N | K | T | Error | (sec) | Error | Reduction | (sec) | Error | Reduction | (sec) |
| Swimwear1 | 575 | 5 | 3 | 3276 | 3.478 | 900 | 2.797 | −19.59% | 39.75 | 2.797 | −19.59% | 39.78 |
| Swimwear2 | 1442 | 4 | 4 | 6818 | 2.21 | 900 | 1.859 | −15.89% | 101.92 | 1.859 | −15.89% | 144.79 |
| Swimwear3 | 1851 | 4 | 6 | 11732 | 2.63 | 900 | 1.949 | −25.89% | 199.71 | 1.949 | −25.89% | 6721.83 |
| Sweaters | 1315 | 6 | 2 | 15188 | 7.37 | 900 | 5.002 | −32.13% | 170.67 | 5.208 | −29.33% | 9000* |
| Swimwear4 | 299 | 4 | 1 | 2691 | 4.933 | 900 | 3.231 | −34.50% | 12.67 | 3.284 | −33.42% | 3535.63 |
| Swimwear5 | 299 | 4 | 1 | 1794 | 3.358 | 900 | 3.13 | −6.79% | 12.38 | 2.923 | −12.95% | 509.68 |
| Swimwear6 | 258 | 4 | 1 | 2580 | 5.411 | 900 | 4.364 | −19.35% | 12.08 | 3.581 | −33.81% | 1877.27 |
| Swimwear7 | 341 | 4 | 2 | 3078 | 3.947 | 900 | 2.716 | −31.19% | 18.72 | 2.686 | −31.94% | 9000* |
| Swimwear8 | 299 | 4 | 1 | 2691 | 5.067 | 900 | 3.298 | −34.91% | 12.54 | 3.726 | −26.47% | 1422.77 |
| Dresses | 1834 | 6 | 3 | 19871 | 5.549 | 900 | 3.725 | −32.87% | 210.71 | 3.698 | −33.35% | 9000* |

*A maximum computation time cap of 9000 seconds (2.5 hours) was set on the Kolon method as some instances were incomplete even after being left to run for several days.
M = the set of locations to receive assortments; N = the set of items in the assortment; K = the set of assortment packs; and T = the total number of units which may be allocated.

As discussed above, Table 1 quantitatively evaluates the performance of the pack optimization system 304 against two state of the art methods. Table 1 illustrates that the pack optimization system 304 is able to achieve its primary goal of improving computation time over the previous target method, resulting in a 91.21% mean and 96.75% median reduction in computation time compared to the previous Target method, as well as an 81.80% mean and 97.88% median reduction in computation time compared to the Kolon method.

In aggregate, the solution quality, in terms of accuracy, are comparable between the pack optimization system 304 and the Kolon method. At a higher level, the pack optimization system 304 mean and median error reductions from the previous Target method are 25.31% and 28.54%, respectively, while the Kolon method mean and median error reductions are 26.23% and 27.93%, respectively.

In addition, it is noted that, with respect to the linear program solver described with respect to the initialization and finalization phases discussed above, only two solutions are stored at any given time (a current solution state and the optimal solution determined up to that point.) Advantageously, this method also limits the memory and computing resources required by the pack optimization system 304 over prior systems, which require storage of all potential solutions before determining a final, optimal solution.

On balance, the comparison of the pack optimization system 304 to existing methods reveals that it can vastly outperform both systems both in terms of a efficiency and scalability without compromising accuracy in terms of identifying a solution that conforms to an idealized demand. The speed of the pack optimization system 304 allows for it to be utilized by a user, such as an inventory analyst, to perform real-time “what if” scenario assessment if a way that is not possible with the existing solutions. An example of a user interface enabling scenario assessment by a user is illustrated and described with respect to FIG. 7.

FIG. 7 illustrates an example user interface displaying an output from the assortment pack optimization system of FIG. 3. In the example shown, the assortment pack optimization system 304 has been deployed as an interactive pack optimization tool such that a user can run one or more “what if” scenarios in an efficient, dynamic manner.

The user interface 700 may be presented on a display 702 of a computing device 704 to a user U. The user U can be a user within the retail enterprise, such as an inventory analyst, procurement specialist, and the like. An optimized configuration and allocation plan 708 may be displayed reflecting the pack optimization system 304 results. The results may be displayed on a store-by-store basis 710, and may include targeted demand (predetermined ideal allocation) 712, optimized assortment pack configuration and allocation 714, and actual assortment 716. Generally speaking, the results displayed in exemplary allocation plan 708 may be utilized by users within the retail enterprise for decision making and implementation with respect to the configuration and allocation of optimized assortment packs for a plurality of stores within the retail enterprise.

The targeted demand 712, for example, may include details reflecting the predetermined ideal allocation of each variant of a core item for a given store. As discussed herein, these targeted demand numbers may be received by the pack optimization system 304 from upstream demand forecasting systems.

Optimized assortment pack configuration and allocation 714 may reflect the optimal assortment pack configurations determined by the pack optimization system 304, the optimized allocation of each respective assortment pack configuration to a given store determined by the pack optimization system 304, or a combination thereof. In the example shown, the optimized assortment pack configuration and allocation 714 displays the configuration of each optimized assortment pack as well as the number of each pack configuration to be allocated to a given store.

Actual assortment 716 reflects the number of each variant upon a core item that a given store will receive based on the optimized assortment pack configuration and allocation determined by the pack optimization system 304. The actual assortment 716 may reflect how well the actual assortment 716 realized for a given store, based on the results from the pack optimization system 304, match the targeted demand 712. In some implementations, an average store error can be displayed. In other implementations, as illustrated in FIG. 7, errors can be highlighted on a store-by-store basis (e.g. over allocation of one or more variant). In some examples, the actual assortment 716 may illustrate the expected delivery timeframe of each of the assortment packs allocated to a given tore, the respective cost of the allocated assortment packs, in terms of shipping and other procurement costs, the respective delivery timing of each of the allocated assortment packs to a given store, or a combination thereof.

The user interface 700 may also include a selectable input 720 to return to the pack optimization tool such that the user can seamlessly alter one or more constraints and view the results. For example, the pack optimization tool may include one or more constraint input fields allowing a user to modify one or more pack configuration constraint, allocation constraint, or both. In this manner, a user can dynamically alter the inputs to the pack optimization system 304 in response to changing demand factors, procurement factors, or in response to the actual assortment 716. For example, a user can return to the pack optimization tool to dynamically alter one or more input constraints based on a change in procurement factors, such as limitation on number of boxes, box size, shipment timing, and the like. In some examples, a user can input one or more additional datasets to be utilized by the pack optimization system 304 in determining a solution. In another example, based on the actual assortments 716, the user can return to the pack optimization tool to alter one or more constraints to reduce the risk of overstocking a location for one or more of the individual item-variants, reduce the number of boxes required to fulfill a targeted demand for a subset of locations to reduce the impact of stochastic shipping elements, and the like. In this manner, a user can perform “what if” scenarios on the fly, enabled by the speed and scalability of the pack optimization system 304. (e.g. “What if the number of different box configurations is reduced to 3 instead of 4 because the supplier offered a discount?” or “What if we paid a fee to increase maximum box size to 25 instead of 20?”)

Finally, the user interface 700 may also include a selectable input 722 to launch a downstream assortment pack implementation tool for implementing the optimized assortment pack configuration and allocation 714. The downstream implementation tool may include, for example, distribution of the assortment pack configuration and allocation results, to one or more downstream systems to rollout the allocation plan 708. For example, the downstream implementation tool may selectably communicate one or more of the optimized assortment pack configurations to a distributor, supplier, directly, or through a downstream procurement system as described herein. For example, the downstream implementation tool may automatically prepare and send an order to a supplier based on an optimized assortment pack configuration and allocation solution. In other examples, the downstream implementation tool may automatically prepare and send an allocation order to an enterprise warehouse system representing the allocation of one or more box configurations to be distributed to at least one retail store. In this manner, the enterprise warehouse can send the optimized allocation of assortment box configurations to each of a plurality of retail stores once the set of optimized assortment boxes are received from a supplier.

In further examples, the implementation tool may include automatically formatting the optimized assortment pack configuration and allocation into set of instructions to be sent to a remote packing system. For example, the set of instructions can be configured as an output file and sent to a remote system and to automatically pack and ship a plurality of assortment packs according to the optimized assortment pack configuration and allocation. For example, a plurality of assortment packs may be automatically packed by the pack assembling system 208 as illustrated and discussed with respect to FIG. 2.

In sum, this streamlined system can allow a user to quickly define one or more constraints, evaluate one or more potential scenario, accurately identify an optimized solution and automatically apply that solution from a single tool.

FIG. 8 illustrates an example block diagram of a virtual or physical computing system 800. One or more aspects of the computing system 800 can be used to implement the processes described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store software instructions and data. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 801. The network 801 is a computer network, such as an enterprise intranet and/or the Internet. The network 801 can include a LAN, a Wide Area Network (WAN), the Internet, wireless transmission mediums, wired transmission mediums, other networks, and combinations thereof. The computing system 800 may connect to the network 801 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

Referring to the present disclosure generally, the disclosed computing system provides a physical environment with which aspects of the pack optimization system described herein may be implemented. It is noted that the disclosure computing system may be used to implement a recommendation computing system, a retail website server, one or more cloud servers used to provide associated services, database servers storing item information, or end-user devices, such as a personal computing system having a browser installed thereon, or a mobile device having either a browser or mobile application installed therein. It is in this environment that scalability of the pack optimization processes described herein may be performed.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of supply chain management systems, technologies disclosed herein are applicable to data and methods for management of operations of a retail enterprise generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A method of configuring and allocating assortment packs of a core item for shipment to a plurality of retail locations in an enterprise, the method comprising:
receiving, at a pack optimization system, a set of constraints and a predetermined targeted assortment demand indicating an ideal allocation of each variant on the core item to each of the plurality of retail store locations;
in an initialization phase:
performing a k-means clustering of retail store locations by similarity of predetermined targeted assortment demand to obtain a plurality of store demand distribution clusters, wherein a centroid of each cluster represents a percentage of each variant upon the core item expected to be allocated to the retail stores included in the cluster;
generating a set of pack sizes based on the set of constraints;
generating, on a cluster-by-cluster basis, a set of potential pack configurations for each pack size according to the centroid of each respective cluster, wherein each pack configuration includes a series of integer values quantifying a number of units of each variant included in the pack configuration;
in an iteration phase:
performing a simulated annealing process to output one or more adjusted variables within an overall solution space to define a local solution space, wherein the overall solution space is defined, at least in part, by the initial set of pack configurations;
performing a linear integer solving processes within the local problem space to identify optimized configuration and allocation of assortment packs to each of the plurality of retail store locations; and
displaying the optimized configuration and allocation of assortment packs within an interactive pack optimization tool.

2. The method of claim 1, wherein the core item corresponds to an apparel item and the variations upon the core item correspond to at least one of a color or a size.

3. The method of claim 1, wherein the set of constraints includes one or more of:
a configuration constraint selected from a set of configuration constraints, wherein the set of configuration constraints include one or more of:
a maximum pack size;
a minimum pack size;
a maximum number of packs per retail store location;
a minimum number of units of each variation upon the core item per retail store location; and
an allocation constraint selected from a set of allocation constraints, wherein the set of allocation constraints include one or more of:
a total number of allocation units; and
an impression minimum.

4. The method of claim 3, wherein the interactive pack optimization tool comprises a one or more constraint input field allowing a user to modify each constraint within the set of constraints.

5. The method of claim 1, wherein the interactive pack optimization tool further comprises a selectable input to launch a downstream assortment pack implementation tool for implementing the optimized configuration and allocation solution.

6. The method of claim 1, wherein the simulated annealing process comprises a series of simulated annealing steps and the iteration phase further comprises performing a minimum number of simulated annealing steps prior to performing the linear integer solving processes.

7. The method of claim 1, wherein the set of constraints includes an impression minimum constraint and the pack optimization system is further configured to, in a finalization phase apply an impression minimum heuristic, wherein the impression minimum heuristic is configured to:
identify one or more leftover assortment pack, within the solution, not assigned to any of the plurality of retail store locations;
identify, based on the solution, at least one understocked retail store location not meeting the impression minimum constraint; and
distribute the one or more leftover pack to the at least one understocked retail store location.

8. The method of claim 1, wherein the pack optimization system is further configured to, in an implementation phase:
automatically configuring the optimized configuration and allocation of assortment packs as a file containing a set of packing instructions;
programming an automated pack assembling system according to the set of packing instructions; and
automatically, by the pack assembling system, placing a number of units of each variation upon the core item into a box according to the optimized configuration and allocation of assortment packs.

9. A system for of configuring and allocating assortment packs of a core item for shipment to a plurality of retail locations, the system comprising:
a processing device;
a data store comprising a predetermined ideal allocation of each variant on the core item to each of a plurality of retail store locations in a retail enterprise and at least one constraint; and
a memory device comprising instructions that, when executed by the processing device implement a pack optimization system configured to:
receive at least one pack configuration constraint and a predetermined targeted assortment demand indicating an ideal allocation of each variant on the core item to each of the plurality of retail store locations;
in an initialization phase:
perform a k-means clustering of retail store locations by similarity of predetermined targeted assortment demand to obtain a plurality of store demand distribution clusters, wherein a centroid of each cluster represents a percentage of each variant upon the core item expected to be allocated to the retail stores included in the cluster;
generate a set of pack sizes based on at the least one pack configuration constraint;
generate, on a cluster-by-cluster basis, a set of potential pack configurations for each pack size according to the centroid of each respective cluster, wherein each pack configuration includes a series of integer values quantifying a number of units of each variant included in the pack configuration;
in an iteration phase:
perform a simulated annealing process to output one or more adjusted variables within an overall solution space to define a local solution space, wherein the overall solution space is defined, at least in part, by the initial set of pack configurations;
perform a linear integer solving processes within the local problem space to identify an optimized configuration and allocation of assortment packs to each of the plurality of retail store locations; and
display the optimized configuration and allocation of assortment packs within an interactive pack optimization tool.

10. The system of claim 9, wherein the core item corresponds to an apparel item and the variations upon the core item correspond to at least one of a color or a size.

11. The system of claim 9, wherein the set of constraints includes one or more of:
a configuration constraint selected from a set of configuration constraints, wherein the set of configuration constraints include one or more of:
a maximum pack size;
a minimum pack size;
a maximum number of packs per retail store location;
a minimum number of units of each variation upon the core item per retail store location; and
an allocation constraint selected from a set of allocation constraints, wherein the set of allocation constraints include one or more of:
a total number of allocation units; and
an impression minimum.

12. The system of claim 11, wherein the interactive pack optimization tool comprises a one or more constraint input field allowing a user to modify each constraint within the set of constraints.

13. The system of claim 9, wherein the interactive pack optimization tool further comprises a selectable input to launch a downstream assortment pack implementation tool for implementing the optimized configuration and allocation solution.

14. The system of claim 9, wherein the simulated annealing process comprises a series of simulated annealing steps and the iteration phase further comprises performing a minimum number of simulated annealing steps prior to performing the linear integer solving processes.

15. The system of claim 9, wherein the set of constraints includes an impression minimum constraint and the pack optimization system is further configured to, in a finalization phase apply an impression minimum heuristic, wherein the impression minimum heuristic is configured to:
identify one or more leftover assortment pack, within the solution, not assigned to any of the plurality of retail store locations;
identify, based on the solution, at least one understocked retail store location not meeting the impression minimum constraint; and
distribute the one or more leftover pack to the at least one understocked retail store location.

16. The method of claim 9, wherein the pack optimization system is further configured to, in an implementation phase:
automatically configuring the optimized configuration and allocation of assortment packs as a file containing a set of packing instructions;
programming an automated pack assembling system according to the set of packing instructions; and
automatically, by the pack assembling system, printing a shipping label identifying a respective retail store that a respective box is allocated to according to the optimized configuration and allocation of assortment packs.

17. A method of configuring and allocating assortment packs of a core item for shipment to a plurality of retail locations in an enterprise, the method comprising:
receiving, at a pack optimization system, a set of constraints and a predetermined targeted assortment demand indicating an ideal allocation of each variant on the core item to each of the plurality of retail store locations;
in an initialization phase:
performing a k-means clustering of retail store locations by similarity of predetermined targeted assortment demand to obtain a plurality of store demand distribution clusters;
generating a set of pack sizes based on at the least one pack configuration constraint;
generating, on a cluster-by-cluster basis, a set of potential pack configurations, wherein each pack configuration includes a series of integer values quantifying a number of units of each variant included in the pack configuration;
in an iteration phase:
performing a simulated annealing process to output one or more adjusted variables within an overall solution space to define a local solution space, wherein the overall solution space is defined, at least in part, by the initial set of pack configurations;
performing a linear integer solving processes within the local problem space to identify a solution, wherein the solution includes a configuration and allocation of assortment packs to each of the plurality of retail store locations;
in a finalization phase:
applying one or more heuristic to the solution to return an optimized configuration and allocation solution; and
displaying the optimized configuration and allocation solution within an interactive pack optimization tool.

18. The method of claim 17, wherein the set of constraints includes one or more of:
a configuration constraint selected from a set of configuration constraints, wherein the set of configuration constraints include one or more of:
a maximum pack size;
a minimum pack size;
a maximum number of packs per retail store location;
a minimum number of units of each variation upon the core item per retail store location; and
an allocation constraint selected from a set of allocation constraints, wherein the set of allocation constraints include one or more of:
a total number of allocation units; and
an impression minimum.

19. The method of claim 17, wherein the interactive pack optimization tool comprises a one or more constraint input field allowing a user to modify each constraint within the set of constraints.

20. The method of claim 15, wherein the pack optimization system is further configured to, in an implementation phase:
automatically configuring the optimized configuration and allocation of assortment packs as a file containing a set of packing instructions;
programming an automated pack assembling system according to the set of packing instructions; and
automatically, by the pack assembling system, placing a number of units of each variation upon the core item into a box according to the optimized configuration and allocation of assortment packs.
